(19) United States
(12) Patent Application Publication
(10) Pub. No.: US 2024/0360269 A1
(43) Pub. Date: Oct. 31, 2024

(54) CO-POLYESTER POLYOLS AND CO-POLYESTERS INCLUDING GLYCOLS AND POLYURETHANES AND SPANDEX PRODUCED THEREFROM

(71) Applicant: THE LYCRA COMPANY LLC, Wilmington, DE (US)

(72) Inventors: OGUZHAN CELEBI, Waynesboro, VA (US); QUN SUN, Wilmington, DE (US); NICHOLAS E. KURLAND, Staunton, VA (US)

(21) Appl. No.: 18/579,341

(22) PCT Filed: Jul. 11, 2022
(86) PCT No.: PCT/US2022/036640

§ 371 Date: Jan. 13, 2024

Related U.S. Application Data
(60) Provisional application No. 63/222,290, filed on Jul. 15, 2021.

(51) Int. Cl. C08G 18/42; D01D 5/06; D01F 6/70

(52) U.S. Cl. CPC C08G 18/4238; D01D 5/06; D01F 6/70; D10B 2331/10; D10B 2401/061

(57) ABSTRACT

Co-polyester glycols and polyurethanes and poly(urethane ureas) derived from mixtures containing 2-methyl-1,4-butanediol, articles of manufacture thereof and methods for their production and use are provided.

This patent application claims the benefit of priority from U.S. Provisional Application Ser. No. 63/222,290 filed Jul. 15, 2021, the contents of which are herein incorporated by reference in their entirety.

### FIELD

This disclosure relates to co-polyester polyols and co-polyesters such as glycols derived from a mixture of 2-methyl-1,4-butanediol and 1,4-butanediol and polyurethanes and differentiated spandex fiber produced therefrom.

### BACKGROUND

Polyols, and in particular glycols, are a class of building block materials that are very useful in preparing segmented elastomers as the soft segments of final products. Two common types of glycols are polyether glycols, such as poly(tetramethylene ether) glycol (PTMEG) and polyester glycols, such as poly(1,4-butylene adipate)s. Polyether glycols, especially PTMEG, have superior resistance to hydrolytic degradation, good mechanical properties' retention at low temperature, desirable processing characteristics and dynamic properties, e.g. high recovery forces when incorporated in elastomers. Typical polyester glycols have higher melting temperatures and viscosities relative to polyether glycols that can result in processability challenges. As a result, spandex fibers are nearly exclusively made with PTMEGs as the soft segments for their excellent durability and elasticity when used in textile and personal care applications.

Addition of the random co-polyether glycol 3MCPG (3-methyl copolymer glycol or poly(tetramethylene-co-2-methyltetramethylene ether) glycol), a random co-polyether glycol derived from THE and 3-methyl-THF monomers, can further improve the low temperature mechanical and dynamic properties of the elastomers, compared to products made solely from homopolyether glycols such as PTMEG or polypropylene glycol (PPG).

Elastic fiber of polyester glycol-based polymer can be prepared by reacting the polyester glycol with a diisocyanate yielding a capped glycol, then chain extending the resulting capped glycol with a diamine in an organic solvent, followed by a dry spinning process.

Many hydroxy terminated polyesters prepared from dicarboxylic acids and glycols have been disclosed over the years for producing the spandex fibers. However, due to major deficiencies of resultant spandex fibers in both hydrolytical stability and mechanical properties, successful commercial introduction and market penetration is limited, and PTMEG is still by far the dominant soft segment building block for spandex fiber.

Attempts have been made to overcome the above-mentioned deficiencies with common polyester glycols.

For example, U.S. Pat. No. 3,097,192 discloses spandex fiber produced using polyester glycols that are made with hindered glycols such as 2,5-hexanediol and 2,2-dimethyl-1,3-propanediol to enhance the hydrolytic stability of the spandex fibers.

U.S. Pat. Nos. 4,767,828 and 4,871,818 disclose polyester glycols based on poly (2,2-dimethyl-1,3-propylene 1,12-dodecandioate) glycols to further enhance the hydrolytic resistance in the spandex fibers. However, 1,12-dodecanedioic acid is considerably more expensive than adipic acid as the building block for preparing the soft segment for spandex fibers.

For many general co-polyester glycol end use applications, e.g. coatings, adhesive, and so on, the above mentioned co-polyester glycols are likely good enough for the intended purposes. However, there is an unmet need for a proper class of affordable co-polyester glycols suitable for spandex fiber production and end use applications such as in textile products.

U.S. Pat. Nos. 4,590,312 and 4,879,420A disclose the use of a mixture of 2-methyl-1,4-butanediol and 1,4-butanediol in a modified process for 1,4-butanediol production. To date, pure 2-methyl-1,4-butanediol is not available in commercial quantities at an affordable cost for use in merchant market applications.

There is a need for affordable co-polyester polyols, and in particular glycols, suitable for spandex fiber production and other more demanding end use applications where improved mechanical and dynamic performances and low temperature flexibility are required.

### SUMMARY

This disclosure relates to practical and economical production of co-polyester polyols such as glycols and other downstream spandex and polyurethane-based products based on 2-methyl-1,4-butanediol and 1,4-butanediol mixtures with varying ratios. The 2MeBDO/BDO mixtures disclosed herein are expected to be suitable for spandex fiber production and other more demanding end use applications where improved mechanical and dynamic performances and low temperature flexibility are required.

An aspect of this disclosure relates to poly(urethane urea) and polyurethane compositions based on a polybutylene adipate copolymer glycol which is a co-polyester glycol of adipic acid and 1,4-butanediol and 2-methyl-1,4-butanediol.

In one nonlimiting embodiment, the poly(urethane urea) composition is the reaction product of a prepolymer comprising the reaction product of: a co-polybutylene adipate ester glycol incorporating 2-methyl-1,4-butanediol and 1,4-butanediol and adipic acid monomers to form a co-polyester glycol or the latter two monomers to form a polyester glycol or glycol blends with varying ratios of polybutylene adipate-based co-polyester glycols and polyether glycols; a diisocyanate; a diamine chain extender; and an amine terminator, typically a dialkyl amine terminator.

In one nonlimiting embodiment, the poly(urethane urea) composition is the reaction product of a capped glycol comprising the reaction product of: a polybutylene adipate glycol incorporating 2-methyl-1,4-butanediol and 1,4-butanediol and adipic acid monomers to form a co-polyester glycol or the latter two monomers to form polyester glycols or glycol blends with varying ratios of polybutylene adipate-based co-polyester glycol and polyether glycols; a diisocyanate; a diamine chain extender; and a dialkyl amine terminator.

Another aspect of this disclosure relates to an elastomeric fiber comprising a poly(urethane urea) composition based on a polybutylene copolymer glycol which is a co-polyester glycol of adipic acid, 1,4-butanediol and 2-methyl-1,4-butanediol.

Another aspect of this disclosure relates to an article of manufacture, at least a portion of which comprises a poly(urethane urea) composition based on a polybutylene adipate copolymer glycol which is a co-polyester glycol of adipic acid and 1,4-butanediol and 2-methyl-1,4-butanediol.

Another aspect of the present invention relates to a method for producing a poly(urethane urea) composition based on a polybutylene adipate copolymer glycol which is a co-polyester glycol of adipic acid and 1,4-butanediol and 2-methyl-1,4-butanediol. The method comprises contacting a glycol or glycol blend formed from a polybutylene adipate glycol incorporating 2-methyl-1,4-butanediol and 1,4-butanediol and adipic acid monomers and a diisocyanate to form a capped glycol. The method further comprises contacting the capped glycol with a diamine chain extender and a dialkylamine chain terminator in a solvent to form a poly(urethane urea) in solution.

Yet another aspect of the present invention relates to a method for spinning spandex fibers from a poly(urethane urea) composition based on a polybutylene adipate copolymer glycol which is a co-polyester glycol of adipic acid and 1,4-butanediol and 2-methyl-1,4-butanediol in solution.

### DETAILED DESCRIPTION

A fiber is defined herein as a shaped article in the form of a thread or a filament with an aspect ratio, the ratio of length to diameter, of more than 200. A “fiber” can be a single filament or multifilaments and can be used interchangeably with a “yarn”.

Spandex fiber meets the definition of “a manufactured fiber in which the fiber-forming substance is a long chain synthetic polymer comprised of at least 85% of a segmented polyurethane”. These are elastomeric fibers.

A glycol, as used herein, is a polymeric diol with a hydroxyl group at each chain end. This term can be used interchangeably with a polyol.

Polyols, and in particular glycols, with two or more different repeat units may be used by blending or copolymerizing. From the perspective of strength and recoverability, use of polyols such as glycols that blend co-polybutylene polyester glycol with PTMEG or 3MCPG is preferred.

The % NCO of the prepolymer or the capped glycol is defined as the weight percent of —NCO groups in the capped glycol prepolymer after completion of the capping reaction, which can be determined experimentally by a titration method.

The capping ratio (CR) is defined as the molar ratio of the diisocyanate to the glycol used in the prepolymerization step. In case of multiple diisocyanate compounds and/or glycols are used in the reaction, the average molecular weights should be used in calculating the capping ratio. Assuming both diisocyanate compounds and glycols are all bi-functional, the capping ratio is the same as the ratio of total number of isocyanate (—NCO) groups to the total number of hydroxyl (—OH) groups.

As used herein, a “solvent” refers to an organic solvent such as dimethylacetamide (DMAC), dimethylformamide, (DMF) and N-methylpyrrolidone (NMP) in which the spandex polymer can form a homogeneous solution.

An additive is defined herein as a substance added in the fiber in a small amount to improve the appearance, performance and quality in manufacture, storage, processing and use of the fiber. An additive by itself may not be capable of fiber forming.

The term “polymerization”, as used herein, unless otherwise indicated, includes the term “copolymerization” within its meaning.

This disclosure relates to co-polyether ester polyols and co-polyesters such as glycols derived from a mixture of 2-methyl-1,4-butanediol and 1,4-butanediol and to methods for production and their use in spandex fiber and articles of manufacture comprising the spandex fiber. Co-polyester glycols of this disclosure have a broad range of uses in the polyurethane industries including, but not limited to, spandex fiber, coatings, adhesive, sealants, polyurethane dispersions, synthetic leathers and cast and thermoplastic elastomers.

This disclosure also relates to spandex fiber based on segmented polyurethanes with alternating soft and hard blocks including diamine chain extended poly(urethane urea)s or diol extended equivalents including polybutylene adipate or copolymer glycol including asymmetric 2-methyl-1,4-butanediol as a comonomer and blends of polybutylene adipate or copolymer glycol with polyether glycols for use in textile and personal care applications including, but not limited to, fabrics with knitting, weaving, non-wovens and laminated articles.

It is well recognized that a more ordered repeating unit in a linear polymer such as 1,4-butylene adipate polyester glycol leads to a higher crystallinity, higher crystallization temperature and melting temperature, thus limiting their applications in certain fields. For example, straight poly(1,4-butylene adipate) glycol has not been used successfully in spandex fiber production as its high crystalline structure leads to poor recovery force in the spandex fiber. To reduce its crystallinity, a common practice is to introduce a second glycol, e.g. ethylene glycol, neopentyl glycol or 1,6-hexanediol and so on into the polymer chain. The co-polyester glycols of 1,4-butylene adipate with ethylene glycol, 1,6-hexylene glycol or neopentyl glycol are commercially available. However, most of these second glycols used in the co-polyesters have symmetric structures and their effectiveness in randomizing the copolymer structure is limited. Thus, high loading of the second glycol is often required which in turn can lead to drastically different overall properties in the final product. Those co-polyester glycols derived spandex fibers often do not have sufficient retractive force essential for the spandex fiber end use applications. As a result, to date, there is no significant use of the poly 1,4-butylene adipate based co-polyester glycols in the spandex fiber manufacturing.

On the other hand, 2-methyl-1,4-butanediol, HOCH₂CH(CH₃)CH₂CH₂OH, is totally asymmetric. When incorporated in a linear polymer chain, the substituting methyl group can be at the 2- or 3-positions. Also, the carbon atom with the substituting methyl group (—CH₃) attached to it in the molecule is a chiral center, i.e. it can have two different conformations that can further enhance the randomness of the polymer structure once incorporated into a linear polymer chain. Therefore, at relatively lower levels of incorporation, 2-methyl-1,4-butanediol can more effectively reduce the crystallinity of the co-polyester glycol product to bring desirable property modifications, e.g. reduced melting point, higher flexibility, higher recovery in elastomers and better impact resistance.

The diacid composition of the feedstock for preparing the co-polyester glycols may be selected from simple alpha-omega alkanedioic acids of formula HO₂C—(CH₂)ₙ—CO₂H where n may range from 2 through 10, including succinic acid, glutaric acid, adipic acid, pimelic acid, suberic acid, azelaic acid, sebacic acid, undecanedioic acid, dodecanedioic acid, or a combination thereof. Commercially available combinations of diacids may be used, for example the mixtures of succinic, glutaric, and adipic acids as DBA Dibasic Acid and mixtures of mainly C11 and C12 dicarboxylic acids as Corfree® M1 from INVISTA S.à r.l.

The spandex fibers and fabrics containing such spandex fibers of this disclosure comprise the reaction product of polybutylene adipate and poly 2-methyl-butylene adipate or copolymer glycol or of a mixture of at least one polybutylene adipate copolymer glycol and at least one other polyether glycol such as PTMEG or 3MCPG. In the glycol blend, the weight percent of the other polyether glycol, such as 3MCPG, may be used in any suitable amount such as more than about 25% by weight of the glycol blend.

In some embodiments, mixed or blended glycols of similar molecular weights are used for spandex fibers for ingredient cost reductions or for property modifications and product performance enhancements such as increased recovery force and higher elongation of the final article.

Suitable glycols regardless of the chemistry may include number average molecular weight of about 600 to about 4,000 g/mole. Mixtures of two or more glycols or copolymers can be included.

The intrinsic viscosity of the polymer is an indicator of the molecular weight of the polymer. For purposes of this disclosure, the poly(urethane urea) including the glycol blend may have an intrinsic viscosity of 0.90 to about 1.20 dL/g.

Examples of polyether glycols that can be used include those glycols with two or more hydroxy groups, from ring-opening polymerization and/or copolymerization of ethylene oxide, propylene oxide, trimethylene oxide, tetrahydrofuran, and 3-methyltetrahydrofuran, or from condensation polymerization of a polyhydric alcohol, such as a diol or diol mixtures, with less than 12 carbon atoms in each molecule, such as ethylene glycol, 1,3-propanediol, 1,4-butanediol, 1,5-pentanediol, 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear, bifunctional polyether glycol is preferred, and a poly(tetramethylene ether) glycol of molecular weight of about 1,700 to about 2,900, such as Terathane® 1800 (The LYCRA Company, DE, USA) with a functionality of 2, is one example of a specific suitable glycol. Copolymers can include poly(tetramethyleneether-co-ethyleneether) glycol and poly(tetramethylene ether-co-2-methyltetramethylene ether) glycol.

Also provided by this disclosure are methods to produce the spandex fiber including a poly(urethane urea) with the use of polybutylene adipate or copolymer glycol or blended glycols with a polyether glycol. In these methods, the mixed glycol is reacted with an excess diisocyanate to form an isocyanate-terminated prepolymer (capped glycol). The prepolymer is diluted with an aprotic polar solvent and further reacted with an aliphatic diamine or a diamine mixture chain extender and a dialkylamine terminator in the solvent. The formed poly(urethane urea) solution can then be spun into fibers through a solution spinning process such as a dry-spinning process or a wet-spinning process. The polymer molecular weights of the spandex polymer are controlled to balance the needs for manufacturing processability and for product performance.

In one nonlimiting embodiment, the poly(urethane urea) for the spandex fibers is prepared by a two-step process.

In the first step, an isocyanate-terminated urethane prepolymer or capped glycol is formed by reacting a blend of two or more glycols with a diisocyanate. In the glycol blend, at least one of the components is polybutylene adipate copolymer glycol incorporating 2-methyl-1,4-butanediol, and another component in the glycol blend is PTMEG or a co-polyether glycol (3MCPG). The PTMEG or co-polyether glycol has the number average molecular weight in a range of 1000 to 4000 g/mole.

The capping ratio for preparing the prepolymer, that is the molar ratio of the diisocyanate to the blended glycol, or the ratio of total number of isocyanate groups (—NCO) to the total number of hydroxyl groups (—OH), is controlled in a range of about 1.50 to about 2.50. Optionally, a catalyst can be used to assist the reaction in this prepolymer formation step.

In the second step, the urethane prepolymer or the capped glycol is dissolved in a solvent such as N,N-dimethylacetamide (DMAc) to form a solution from 30 to 50% solids content. This diluted capped glycol solution is then chain extended with a low molecular weight aliphatic primary diamine or a mixture of diamines and optionally terminated with a small amount of dialkylamine at the same time to form the poly(urethane urea) solution. The amount of the diamine chain extender or extenders used should be controlled in such a way that the ratio of the total isocyanate (NCO) end groups (in milliequivalents) from the prepolymer to the total primary amine (NH₂) end groups (in milliequivalents) from the chain extender or extender mixtures is well balanced to achieve the processing controls such as polymer viscosity and product performance. The terminator amount is controlled in a way to control polymer molecular weight.

Additional solvent can be added, during or after the chain extension step, to the polymer solution to adjust the polymer solids in the solution and the solution viscosity. Typically, the solids content in the solution is controlled in a range of 30 to 50% by weight of the solution, and the solution viscosity after the chain extension step is controlled in a range of 2000 to 3500 poises measured at 40° C. by falling ball method.

The additives can be mixed into the polymer solution at any stage after the poly(urethane urea) is formed but before the solution is spun into the fibers. The solid content including the additives in the polymer solution prior to spinning is typically controlled in a range of 30% to 50% by weight of the solution. The viscosity of the solution kept in the storage tank prior to spinning is typically controlled in a range from 3000 to 5000 poise by adjusting the ageing time, agitation speed and tank temperature for optimum spinning performance.

Examples of PTMEG and co-polyether glycols include, but are not limited to, Terathane® PTMEG glycol from The LYCRA Company (Wilmington, Delaware, U.S.A.), Polymeg® glycols from LyondellBasell (Houston, Texas, U.S.A), PolyTHF® glycols from BASF (Geismer, Louisiana, U.S.A.), PTG glycols from Dairen Chemical Corp. (DCC) (Taipei, Taiwan), PTMG glycols from Mitsubishi Chemical Corp (MCC) (Tokyo, Japan), PTMEG glycols from Tianhua Fubang Chemical Industry Ltd Co (Luzhou, Sichuan, China), and PTG & PTG-L glycols from Hodogaya Chemical Co. (Tokyo, Japan), and 3MCPG glycols from The LYCRA Company (Wilmington, Delaware, U.S.A.).

Examples of diisocyanates that can be used include but are not limited to 4,4′-methylene bis(phenyl isocyanate) (also referred to as 4,4′-diphenylmethane diisocyanate (MDI), 2,4′-methylene bis(phenyl isocyanate, 4,4′-methylenebis(cyclohexyl isocyanate), 1,4-xylenediisocyanate, 2,6-toluenediisocyanate, 2,4-toluenediisocyanate, and mixtures thereof. Examples of specific polyisocyanate components include Takenate® 500 (Mitsui Chemicals), Mondur® MB (Bayer), Lupranate® M (BASF), and Isonate® 125 MDR (Dow Chemical), and combinations thereof.

Examples of suitable diamine chain extenders include one or more diamines selected from 1,2-ethylenediamine; 1,4-butanediamine; 1,2-butanediamine; 1,3-butanediamine; 1,3-diamino-2,2-dimethylbutane; 1,6-hexamethylenediamine; 1,12-dodecanediamine; 1,2-propanediamine; 1,3-propanediamine; 2-methyl-1,5-pentanediamine; 1-amino-3,3,5-trimethyl-5-aminomethylcyclohexane; 2,4-diamino-1-methylcyclohexane; N-methylamino-bis(3-propylamine); 1,2-cyclohexanediamine; 1,4-cyclohexanediamine; 4,4′-methylene-bis (cyclohexylamine); isophorone diamine; 2,2-dimethyl-1,3-propanediamine; meta-tetramethylxylenediamine; 1,3-diamino-4-methylcyclohexane; 1,3-cyclohexane-diamine; 1,1-methylene-bis(4,4′-diaminohexane); 3-aminomethyl-3,5,5-trimethylcyclohexane; 1,3-pentanediamine(1,3-diaminopentane); m-xylylene diamine; and Jeffamine® (Huntsman), or any combination thereof.

Examples of suitable diol chain extenders include one or more diols selected from ethylene glycol,1,2-propanediol, 1,3-propanediol,1,3-butanediol, 1,4-butanediol, 1,5-pentane diol, 1,6-hexanediol,2,2-dimethyl-1,3-propane diol, 1,4-cyclohexanedimethanol, decamethylene glycol, dodecamethylene glycol, resorcinol bis(2-hydroxyethyl) ether, aliphatic triols and tetrols, or any combination thereof.

Examples of suitable monofunctional dialkylamine chain terminators include N,N-diethylamine, N-ethyl-N-propylamine, N,N-diisopropylamine, N-tert-butyl-N-methylamine, N-tert-butyl-N-benzylamine, N,N-dicyclohexylamine, N-ethyl-N-isopropylamine, N-tertbutyl-N-isopropylamine, N-isopropyl-N-cyclohexylamine, N-ethyl-N-cyclohexylamine, N,N-diethanolamine, and 2,2,6,6-tetramethylpiperidine.

Examples of suitable monofunctional hydroxyl alcohol chain terminators include ethanol, propanol, butanol, pentanol, hexanol, polyethylene mono alcohols, ethoxylated polyethylene mono alcohols, or any combination thereof.

Exemplary and non-limiting list of additives that may be optionally included are anti-oxidants, UV-stabilizers/screeners, colorants, pigments, cross-linking agents, antimicrobials, microencapsulated additives, flame retardants, anti-tack additives (metal stearates), chlorine degradation resistant additives, dyeability and/or dye-assist agents, delustrant such as titanium dioxide, stabilizers such as hydrotalcite, a mixture of huntite and hydromagnesite, and combinations thereof. Other additives which may be included in the spandex compositions such as adhesion promoters, anti-static agents, optical brighteners, electro-conductive additives, luminescent additives, lubricants, organic and inorganic fillers, preservatives, texturizing agents, wetting agents, stabilizers (hindered phenols, zinc oxide, hindered amine), slip agents (silicone oil) and combinations thereof.

The poly(urethane urea) polymer solution prepared as described above is then spun into spandex fibers through a solution-spinning process in accordance with known procedures in the art.

Another aspect of this disclosure relates to articles of manufacture, at least a portion of which comprises these spandex fibers. Nonlimiting examples include textile and personal care applications including fabrics with knitting, weaving, non-wovens and laminated articles.

### Analytical/Test Methods

The following analytical methods were used.

Determination of the Acid Number for the polyester glycols—The acid number titrations were performed on a Brinkman 716 DMS Titrino instrument using a 0.025 normal KOH solution per the ASTM method D-4662-93.

Determination of the Hydroxyl Number (OH #) or the number average Molecular Weight of the polyester glycols—The titration of the hydroxyl end groups of the polyester glycols per ASTM method E 222 provides the OH # in mg KOH/g from which the number average molecular weight can be calculated in g/mole.

Differential Scanning Calorimetry (DSC) analysis of the polyester glycols and the polyesters—The DSC analysis was carried out in a Q-200 DSC machine from the TA Instrument. In the case of the polyester glycols, the melted glycol sample was loaded into the cell, the sample was equilibrated at 60° C., cooled to −150° C. to follow the crystallization events, then, it was heated back to 60° C. to measure the glass transition temperature (Tg) and the melting events. All the sample cooling and heating cycles were performed at 10° C./min. rate. Examples consist of preparing the co-polyester glycols using the 2-methyl-1,4-butanediol and 1,4-butanediol mixture with different level of 2-methyl-1,4-butanediol, comparative control sample is the straight 1,4-butanediol-based polyester glycol.

Viscosity—The viscosity of the polymer solutions was determined in accordance with the method of ASTM D1343-69 with a Model DV-8 Falling Ball Viscometer (Duratech Corp., Waynesboro, VA), operated at 40° C. and reported as poises.

Percent isocyanate—Percent isocyanate (% NCO) of the capped glycol prepolymer was determined according to the method of S. Siggia. “Quantitative Organic Analysis via Functional Group”, 3rd Edition, Wiley & Sons, New York, pages 559-561 (1963) using a potentiometric titration.

Assessing Strength and Elasticity—The strength and elastic properties of the spandex were measured in accordance with the general method of ASTM D 2731-72. Three filaments, a 2-inch (5-cm) gauge length and a 0-300% elongation cycle were used for each of the measurements. An exception to this is Comparative Example 4 and Example 13, which utilized single-threadline testing in triplicate in lieu of three threadline testing. The samples were cycled five times at a constant elongation rate of 50 centimeters per minute. Load power (TP2), the stress on the spandex during initial extension, was measured on the first cycle at 200% extension and is reported as centinewton for a given decitex (abbreviated as dtex, which is a unit of measurement that indicates the linear mass of yarn in decigrams, per 10,000 meters). Unload power (TM2) is the stress at an extension of 200% for the fifth unload cycle and is also reported in centinewton. Percent elongation at break (ELO) and tenacity (TEN) were measured on a sixth extension cycle.

Assessing Percent Set—Percent set was also measured on samples that had been subjected to five 0-300% elongation/relaxation cycles. The percent set, % SET, was then calculated as:

$$\% SET = 100 \times ( Lf - Lo ) / Lo$$

where Lo and Lf are respectively the filament (yarn) length when held straight without tension before and after the five elongation/relaxation cycles.

### EXAMPLES

The following examples demonstrate the present invention and its capability for use in manufacturing a variety of fabrics. The invention is capable of other and different embodiments, and its several details are capable of modifications in various apparent respects, without departing from the scope and spirit of the present invention. Accordingly, the examples are to be regarded as illustrative in nature and not as restrictive.

### Example 1 & 2: Preparation of Adipate Co-Polyester Glycols with 10.4 Mole % 2-methyl-1,4-butanediol and 89.6 Mole % 1,4-butanediol with Different Molecular Weights Example 1

A 5-liter round bottom flask is fitted with a heating mantle, a set of mechanical stir blades, nitrogen sparge tube, and distillation head, condenser, and distillate receiver. The flask was charged with a reaction mixture comprising 2299 grams of adipic acid and 1696 grams of 2-methyl-1,4-butanediol and 1,4-butanediol mixture with 11.8 wt % or 10.4 mole % 2-methyl-1,4-butanediol and 89.6 mole % 1,4-butanediol. The adipic acid was from INVISTA S.à r.l. and the glycol mixture was from The LYCRA Company. The reaction mixture was sparged with nitrogen for 30 minutes, and then heated gradually to 190° C. with continuous nitrogen sparge. Water of the reaction was condensed and collected in the distillate receiver. After about 15 hours at temperature averaging about 195° C., the reaction mixture was sampled, and acid number was found to be 12 mg KOH (potassium hydroxide)/g. While nitrogen sparge was continued, then 0.19-gram Tyzor® TPT esterification catalyst was added and the reaction was continued for 20 more hours at 200° C. After 35 hours total reaction time, acid number was measured to be 0.25 mg KOH/g. The final co-polyester glycol Hydroxyl number was measured to be 79.5 mg KOH/g, i.e. a number average molecular weight of 1411 g/mole.

### Example 2

In the same set up, the feed composition was changed slightly containing 2375 grams of adipic acid and 1663 grams 2-methyl-1,4-butanediol and 1,4-butanediol mixture with 11.8 wt % or 10.4 mole % 2-methyl-1,4-butanediol and 89.6 mole % 1,4-butanediol. The final polyester glycol has acid number measured to be 0.17 mg KOH/g, the Hydroxyl number was measured to be 54.52 mg KOH/g, i.e. a number average molecular weight of 2058 g/mole.

### Example 3: Preparation of an Adipate Co-Polyester Glycol with 20.4 Mole % 2-methyl-1,4-butanediol and 79.6 Mole % 1,4-Butanediol

A 3-liter round bottom flask is fitted with a heating mantle, a set of mechanical stir blades, nitrogen sparge tube, and distillation head, condenser, and distillate receiver. The flask was charged with a reaction mixture comprising 710 grams adipic acid and 510 grams 2-methyl-1,4-butanediol and 1,4-butanediol mixture with 23.2 wt % or 20.4 mole % 2-methyl-1,4-butanediol and 79.6 mole % 1,4-butanediol. The adipic acid was from INVISTA S.à r.l. the glycol mixture was from The LYCRA Company. The reaction mixture was sparged with nitrogen for 30 minutes, and then heated to 200° C. with continuous nitrogen sparge. Water of the reaction was condensed and collected in the distillate receiver. After about 10 hours, the reaction mixture was sampled, and acid number was found to be 14 mg KOH/g. While nitrogen sparge was continued, then 0.18-gram Tyzor® TPT esterification catalyst was added and the reaction was continued for 8 more hours. After 18 hours of total reaction time, acid number was measured to be 0.25 mg KOH/g. The final co-polyester glycol hydroxyl number was measured to be 64.1 mg KOH/g, i.e. a number average molecular weight of 1750 g/mole.

Since the commercially available batch of (2-methyl-1,4-butanediol/1,4-butanediol) 2MeBDO/BDO mixture only had 2MeBDO at 11.78 wt %, it was further concentrated using the following procedure to double the 2MeBDO concentration in the mixture for the feed to example 3. In the 2-liter upright commercial “ice cream maker” (ICM) with stainless steel bowl was added 1500 g of the 2MeBDO/BDO mixture with 11.78 wt % 2MeBDO. The mixture was partially frozen in the ICM bowl to a slush at approximately 9-11° C. with continual scraping of walls to equilibrate solids and liquid. The slush was transferred into a chilled filtration funnel held at approximately 19-21° C. Vacuum was applied to draw out target supernatant liquid enriched in 2MeBDO due to its lower melting point, to improve the concentrate yield, the BDO-enriched crystals was pressed to disengage liquid. The 2MeBDO content in the recovered liquid filtrate (325 g) and the retained solid (1117 g) were 23.14 wt % and 8.04 wt %, respectively, in one preparation. On the 2^{nd} preparation, the 2MeBDO content in the recovered liquid filtrate (413 g) and the retained solid (1072 g) were 23.11 wt % and 7.13 wt %, respectively.

### Comparative Example 1 & 2: Preparation of 1,4-Butanediol Adipate Polyester Glycols with a Different Molecular Weight

### Comparative Example 1

A 5-liter round bottom flask is fitted with a heating mantle, a set of mechanical stir blades, nitrogen sparge tube, and distillation head, condenser, and distillate receiver. The flask was charged with a reaction mixture comprising 2299 grams adipic acid and 1663 grams of refined 1,4-butanediol. The adipic acid was from INVISTA S.à r.l. and the refined 1,4-butanediol was from The LYCRA Company. The reaction mixture was sparged with nitrogen for 30 minutes, and then heated to about 190° C. with continuous nitrogen sparge. Water of the reaction was condensed and collected in the distillate receiver. After about 10 hours at average temperature of 195° C., the reaction mixture was sampled, and acid number was found to be 18.4 mg KOH/g. While nitrogen sparge was continued, then 0.18-gram Tyzor® TPT esterification catalyst was added and the reaction was continued for about 20 more hours at 200° C. After 30 hours of total reaction time, acid number was measured to be 0.22 mg KOH/g. The final co-polyester glycol hydroxyl number was measured to be 79.9 mg KOH/g, i.e. a number average molecular weight of 1404 g/mole.

### Comparative Example 2

In the same set up the feed composition was changed slightly, it contained 2375 grams adipic acid and 1661 grams 1,4-butanediol. The final polyester glycol has acid number measured to be 0.24 mg KOH/g, the hydroxyl number was measured to be 55.68 mg KOH/g, i.e. a number average molecular weight of 2015 g/mole.

The thermal properties of the above three polyester glycols, i.e. the crystallization temperature (Tc) during the cooling cycle (from 60° C. to −150 at 10° C./min. rate) and the melting temperatures (Tm) during the heating cycle (from −150° C. to 60 at 10° C./min. rate), were determined by DSC and the results are presented below in Table

### Materials for Spandex Production

Terathane® 1800 is a linear poly(tetramethylene ether) glycol (PTMEG), with a number average molecular weight of 1,800 g/mole (commercially available from The LYCRA Company, of Wilmington, DE).

Isonate® 125MDR is a pure mixture of diphenylmethane diisocyanates (MDI) containing ˜98% 4,4′-MDI isomer and ˜2% 2,4′-MDI isomer (commercially available from the Dow Company, Midland, Michigan).

Dytek® A is 2-methyl-1,5-pentamethylenediamine (MPMD) (commercially available from INVISTA S.à r.l., of Wichita, KS).

Terathane® 3MCPG T-1410 is a linear random co-polyether glycol of tetrahydrofuran and 3-methyl-tetrahydrofuran, with a number average molecular weight of 1,450+/−50 g/mole and 10 mole percent of 2-methyl-tetramethylene ether repeat units, from The LYCRA Company, Wilmington, DE, USA.

Terathane® 3MCPG T-2010 is a linear random co-polyether glycol of tetrahydrofuran and 3-methyl-tetrahydrofuran, with a number average molecular weight of 2,000 g/mole and 10 mole percent of 2-methyl-tetramethylene ether repeat units, from The LYCRA Company, Wilmington, DE, USA.

Polybutylene adipate glycol is a polyester glycol of hexanedioic acid and 1,4-butanediol with a number average molecular weight of 1,400 or 2,000 g/mole. Both grades were internally produced by TERATHANE® R&D of The LYCRA Company, Wilmington, DE, USA.

Co-polybutylene polyester glycol is a co-polyester glycol of adipic acid and 1,4-butanediol and 2-methyl-1,4-butanediol. Number of average molecular weights can vary from 1,400 to 2,000 g/mole. 2-methyl-1,4-butanediol may vary from 10 mole % to 20 mole %.

3MCPG stands for 3-methyl co-polyether glycol.

EDA stands for ethylenediamine.

DEA stands for N,N-diethylamine.

### Comparative Example 3 (Fiber T-162C)

A commercially available 44 dtex spandex fiber which is used for general circular and warp knit fabric applications. The as-spun yarn properties of this comparative and other inventive examples (from 4 to 12) are shown in Tables 4 and 5.

### Comparative Example 4 (Fiber T-178C)

A commercially available 44 dtex spandex fiber which is used for general steam settable hosiery and legwear applications. The as-spun yarn properties of this comparative and other inventive example (13) are shown in Table 6.

### Example 4 (Spandex Polymer and Fiber 1906)

Terathane® 3MCPG T-1410 (1465 g/mole) of 225.00 parts by weight and 75 parts of co-polybutylene polyester glycol with 10 mole % of 2-methyl-1,4-butanediol and number average molecular weight of 1411 g/mole were mixed, and this blended glycol was reacted with Isonate® 125MDR MDI of 83.73 parts at 80° C. for 90 min, with a capping ratio of (NCO/OH) at 1.618, to form an isocyanate-terminated prepolymer with a percent of isocyanate groups (—NCO) at 2.80% of the prepolymer. This capped glycol was then dissolved in N,N-dimethylacetamide (DMAc) of 707.50 parts. This diluted prepolymer solution was reacted with a mixture of amines in DMAc solution, containing 6.76 parts of EDA, 1.45 parts of Dytek® A, 0.72 parts of DEA and 125.79 parts of DMAc using a high-speed disperser to form a homogenous poly(urethane urea) solution with a targeted polymer solid content of 32.03% and a viscosity of 2305 poises measured at 40° C. In this polymer, the ratio of the total isocyanate (NCO) end groups (in milliequivalents) from the prepolymer to the total primary amine (NH₂) end groups (in milliequivalents) from the chain extender and terminator amine end groups was 0.985 and the end group concentration from diethylamine terminator was 24.62 mEq per kg of the polymer solids.

This polymer solution was mixed with a slurry of additives including 1.35% antioxidant and 0.42% silicone oil-based spinning aid based on the solid weight. This mixture was spun into 44 decitex spandex yarn with 3 filaments twisted together at a wound-up speed of 869 meters per minute.

### Example 5 (Spandex Polymer and Fiber 1907)

Terathane® 3MCPG T-1410 (1465 g/mole) of 150.00 parts by weight and 150.00 parts of polybutylene adipate copolymer glycol with 10 mole % of 2-methyl-1,4-butanediol and number average molecular weight of 1411 g/mole were mixed, and this blended glycol was reacted with Isonate® 125MDR MDI of 84.27 parts at 80° C. for 90 min, with the capping ratio (NCO/OH) at 1.613, to form an isocyanate-terminated prepolymer with a percent of isocyanate groups (—NCO) at 2.80% of the prepolymer. This prepolymer was then dissolved in N,N-dimethylacetamide (DMAc) of 707.76 parts. This diluted prepolymer solution was reacted with a mixture of amines in DMAc solution, containing 6.77 parts of EDA, 1.45 parts of Dytek® A, 0.78 parts of DEA and 126.69 parts of DMAc using a high-speed disperser to form a homogenous poly(urethane urea) solution with a targeted polymer solid content of 32.03% and a viscosity of 2157 poise measured at 40° C. In this polymer, the ratio of the total isocyanate (NCO) end groups (in milliequivalents) from the prepolymer to the total primary amine (NH₂) end groups (in milliequivalents) from the chain extender and terminator amine end groups was 0.982 and the end group concentration from diethylamine terminator was 26.51 mEq per kg of the polymer solids.

This polymer solution was mixed with a slurry of additives including 1.35% antioxidant and 0.42% spinning aid based on the solid weight. This mixture was spun into 44 decitex spandex yarn with 5 filaments twisted together at a wound-up speed of 869 meters per minute.

### Example 6 (Spandex Polymer and Fiber 1908)

A polybutylene adipate copolymer glycol with 10 mole % of 2-methyl-1,4-butanediol and number average molecular weight of 1450 g/mole of 200.00 parts by weight was reacted with Isonate® 125MDR MDI of 55.85 parts at 80° C. for 90 min in the presence of 75 ppm phosphoric acid (concentration 85%), with the capping ratio (NCO/OH) at 1.618, to form an isocyanate-terminated prepolymer with a percent of isocyanate groups (—NCO) at 2.80% of the prepolymer. This prepolymer was then dissolved in N,N-dimethylacetamide (DMAc) of 447.69 parts. This diluted prepolymer solution was reacted with a mixture of amines in DMAc solution, containing 4.52 parts of EDA, 0.97 parts of Dytek® A, 0.40 parts of DEA and 83.14 parts of DMAc using a high-speed disperser to form a homogenous poly(urethane urea) solution with a targeted polymer solid content of 33.02% and a viscosity of 3338 poise measured at 40° C. In this polymer, the ratio of the total isocyanate (NCO) end groups (in milliequivalents) from the prepolymer to the total primary amine (NH₂) end groups (in milliequivalents) from the chain extender and terminator amine end groups was 0.988 and the end group concentration from diethylamine terminator was 20.75 mEq per kg of the polymer solids.

This polymer solution was mixed with a slurry of additives including 1.35% antioxidant and 0.42% spinning aid based on the solid weight. This mixture was spun into 44 decitex spandex yarn with 5 filaments twisted together at a wound-up speed of 869 meters per minute.

### Example 7 (Spandex Polymer and Fiber 1909)

Terathane® 3MCPG T-2010 (2017 g/mole) of 225.00 parts by weight and 75.00 parts of polybutylene adipate copolymer glycol with 10 mole % of 2-methyl-1,4-butanediol and number average molecular weight of 2058 g/mole were mixed, and this blended glycol was reacted with Isonate® 125MDR MDI of 60.67 parts at 80° C. for 90 min, with a capping ratio of (NCO/OH) 1.638, to form an isocyanate-terminated prepolymer with a percent of isocyanate groups (% NCO) at 2.20% of the prepolymer. This prepolymer was then dissolved in N,N-dimethylacetamide (DMAc) of 684.26 parts. This diluted prepolymer solution was reacted with a mixture of amines in DMAc solution, containing 5.01 parts of EDA, 1.08 parts of Dytek® A, 0.70 parts of DEA and 95.34 parts of DMAc using a high-speed disperser to form a homogenous poly(urethane urea) solution with a targeted polymer solid content of 32.03% and a viscosity of 2770 poise measured at 40° C. In this polymer, the ratio of the total isocyanate (NCO) end groups (in milliequivalents) from the prepolymer to the total primary amine (NH₂) end groups (in milliequivalents) from the chain extender and terminator amine end groups was 0.970 and the end group concentration from diethylamine terminator was about 25.22 mEq per kg of the polymer solids.

This polymer solution was mixed with a slurry of additives including 1.35% antioxidant and 0.42% spinning aid based on the solid weight. This mixture was spun into 44 decitex spandex yarn with 5 filaments twisted together at a wound-up speed of 869 meters per minute.

### Example 8 (Spandex Polymer and Fiber 1910)

Terathane® 3MCPG T-2010 (2017 g/mole) of 150.00 parts by weight and 150.00 parts of polybutylene adipate copolymer glycol with 10 mole % of 2-methyl-1,4-butanediol and number average molecular weight of 2058 g/mole were mixed, and this blended glycol was reacted with Isonate® 125MDR MDI of 60.47 parts at 80° C. for 90 min, with a capping ratio of (NCO/OH) 1.641, to form an isocyanate-terminated prepolymer with a percent of isocyanate groups (% NCO) at 2.20% of the prepolymer. This prepolymer was then dissolved in N,N-dimethylacetamide (DMAc) of 684.22 parts. This diluted prepolymer solution was reacted with a mixture of amines in DMAc solution, containing 5.00 parts of EDA, 1.08 parts of Dytek® A, 0.67 parts of DEA and 94.95 parts of DMAc using a high-speed disperser to form a homogenous poly(urethane urea) solution with a targeted polymer solid content of 32.03% and a viscosity of 2415 poise measured at 40° C. In this polymer, the ratio of the total isocyanate (NCO) end groups (in milliequivalents) from the prepolymer to the total primary amine (NH₂) end groups (in milliequivalents) from the chain extender and terminator amine end groups was 0.972 and the end group concentration from diethylamine terminator was about 24.29 mEq per kg of the polymer solids.

This polymer solution was mixed with a slurry of additives including 1.35% antioxidant and 0.42% spinning aid based on the solid weight. This mixture was spun into 44 decitex spandex yarn with 5 filaments twisted together at a wound-up speed of 869 meters per minute.

### Example 9 (Spandex Polymer and Fiber 1911)

A polybutylene adipate copolymer glycol with 10 mole % of 2-methyl-1,4-butanediol and number average molecular weight of 2150 g/mole of 200.00 parts by weight was reacted with Isonate® 125MDR MDI of 40.47 parts at 80° C. for 90 min in the presence of 75 ppm phosphoric acid (concentration 85%), with the capping ratio (NCO/OH) at 1.738, to form an isocyanate-terminated prepolymer with a percent of isocyanate groups (—NCO) at 2.40% of the prepolymer. This prepolymer was then dissolved in N,N-dimethylacetamide (DMAc) of 387.63 parts. This diluted prepolymer solution was reacted with a mixture of amines in DMAc solution, containing 3.65 parts of EDA, 0.78 parts of Dytek® A, 0.34 parts of DEA and 67.33 parts of DMAc using a high-speed disperser to form a homogenous poly(urethane urea) solution with a targeted polymer solid content of 35.02% and a viscosity of 2900 poise measured at 40° C. In this polymer, the ratio of the total isocyanate (NCO) end groups (in milliequivalents) from the prepolymer to the total primary amine (NH₂) end groups (in milliequivalents) from the chain extender and terminator amine end groups was 0.984 and the end group concentration from diethylamine terminator was 18.70 mEq per kg of the polymer solids.

This polymer solution was mixed with a slurry of additives including 1.35% antioxidant and 0.42% spinning aid based on the solid weight. This mixture was spun into 44 decitex spandex yarn with 5 filaments twisted together at a wound-up speed of 869 meters per minute.

### Example 10 (Spandex Polymer and Fiber 1912)

A polybutylene adipate glycol with a number average molecular weight of 2015 g/mole of 250.00 parts by weight was reacted with Isonate® 125MDR MDI of 50.75 parts at 80° C. for 60 min, with the capping ratio (NCO/OH) at 1.635, to form an isocyanate-terminated prepolymer with a percent of isocyanate groups (—NCO) at 2.20% of the prepolymer. This prepolymer was then dissolved in N,N-dimethylacetamide (DMAc) of 515.77 parts. This diluted prepolymer solution was reacted with a mixture of amines in DMAc solution, containing 4.18 parts of EDA, 0.90 parts of Dytek® A, 0.47 parts of DEA and 78.08 parts of DMAc using a high-speed disperser to form a homogenous poly(urethane urea) solution with a targeted polymer solid content of 34.03% and a viscosity of 2185 poise measured at 40° C. In this polymer, the ratio of the total isocyanate (NCO) end groups (in milliequivalents) from the prepolymer to the total primary amine (NH₂) end groups (in milliequivalents) from the chain extender and terminator amine end groups was 0.979 and the end group concentration from diethylamine terminator was 20.56 mEq per kg of the polymer solids.

This polymer solution was mixed with a slurry of additives including 1.35% antioxidant and 0.42% spinning aid based on the solid weight. This mixture was spun into 44 decitex spandex yarn with 5 filaments twisted together at a wound-up speed of 869 meters per minute.

### Example 11 (Spandex Polymer and Fiber 1914)

A polybutylene adipate glycol with a number average molecular weight of 1385 g/mole of 200.00 parts by weight was reacted with Isonate® 125MDR MDI of 57.62 parts at 80° C. for 100 min in the presence of 75 ppm phosphoric acid (concentration 85%), with the capping ratio (NCO/OH) at 1.594, to form an isocyanate-terminated prepolymer with a percent of isocyanate groups (—NCO) at 2.80% of the prepolymer. This prepolymer was then dissolved in N,N-dimethylacetamide (DMAc) of 426.46 parts. This diluted prepolymer solution was reacted with a mixture of amines in DMAc solution, containing 4.57 parts of EDA, 0.98 parts of Dytek® A, 0.44 parts of DEA and 84.57 parts of DMAc using a high-speed disperser to form a homogenous poly(urethane urea) solution with a targeted polymer solid content of 34.03% and a viscosity of 2663 poise measured at 40° C. In this polymer, the ratio of the total isocyanate (NCO) end groups (in milliequivalents) from the prepolymer to the total primary amine (NH₂) end groups (in milliequivalents) from the chain extender and terminator amine end groups was 0.980 and the end group concentration from diethylamine terminator was 22.55 mEq per kg of the polymer solids.

This polymer solution was mixed with a slurry of additives including 1.35% antioxidant and 0.42% spinning aid based on the solid weight. This mixture was spun into 44 decitex spandex yarn with 5 filaments twisted together at a wound-up speed of 869 meters per minute.

### Example 12 (Spandex Polymer and Fiber 2011)

A polybutylene adipate copolymer glycol with 20 mole % of 2-methyl-1,4-butanediol and number average molecular weight of 1455 g/mole of 300.00 parts by weight was reacted with Isonate® 125MDR MDI of 83.58 parts at 90° C. for 90 min in the presence of 60 ppm phosphoric acid (concentration 85%), with the capping ratio (NCO/OH) of 1.620, to form an isocyanate-terminated prepolymer with a percent of isocyanate groups (—NCO) at 2.80% of the prepolymer. This prepolymer was then dissolved in N,N-dimethylacetamide (DMAc) of 654.91 parts. This diluted prepolymer solution was reacted with a mixture of amines in DMAc solution, containing 6.77 parts of EDA, 1.46 parts of Dytek® A, 0.49 parts of DEA and 123.20 parts of DMAc using a high-speed disperser to form a homogenous poly(urethane urea) solution with a targeted polymer solid content of 33.52% and a viscosity of 2542 poise measured at 40° C. In this polymer, the ratio of the total isocyanate (NCO) end groups (in milliequivalents) from the prepolymer to the total primary amine (NH₂) end groups (in milliequivalents) from the chain extender and terminator amine end groups was 0.994 and the end group concentration from diethylamine terminator was 16.90 mEq per kg of the polymer solids.

This polymer solution was mixed with a slurry of additives including 1.35% antioxidant and 0.42% spinning aid based on the solid weight. This mixture was spun into 44 decitex spandex yarn with 5 filaments twisted together at a wound-up speed of 869 meters per minute.

### Example 13

A poly (tetramethylene ether) glycol with number average molecular weight of 2000 g/mole of 600.00 parts by weight, Isonate® 125MDR MDI of 214.55 parts and N,N′-dimethylacetamide (DMAc) were added to a jacketed kettle fitted with a helical ribbon stir rod. The mixture was stirred by a torque-sensing motor at 120 rpm until it reached a temperature of 65° C. A solution of 675 parts DMAc, 50.29 parts of a 90:10 mixture w/w of 1,4-butanediol and 2-methyl-1,4-butanediol, and 35 L phosphoric acid (concentration 85%) was added to the kettle. The kettle was stirred at 20 rpm until the torque reached 220 N-cm over a period of 4.5 hours. A solution of 34 parts DMAc, 6 parts Irganox® 245, and 5 parts butanol was added to the kettle. The kettle was allowed to stir for an additional 60 minutes at 65° C. A solution of 2 parts DMAc and 0.5 parts cyclohexylamine were added to the kettle. The kettle was allowed to stir for an additional 30 minutes at 65° C. The reaction as stopped. The 39% solids solution was spun into a 19.6 dtex monofilament fiber at 530 m/min. Yarn mechanical properties are listed in Table 4 with a comparative example 4.

### Summary of Examples

The data in Table 1 show that the incorporation of the 2-methyl-1,4-butanediol into the co-polyester glycols had significantly reduced the crystallization temperature (Tc) and the melting temperatures (Tm) even at relatively low level of incorporations, e.g. 5.0 wt % of 2-methyl-1,4-butanediol to co-polybutylene polyester glycols in examples 1 & 2 and likewise 9.7 wt % of the same ingredient to the co-polyester glycol in example 3 in comparison to the straight 1,4-butylene adipate polyester glycol, the comparative examples 1 & 2.

The compositional information for both polyester glycols and poly (urethane urea)s are listed in Table 2. Details of the polymer formulations for the blended glycol systems and poly(urethane urea)s utilizing these mixed glycols are summarized in Table 3.

The as-spun yarn properties of fibers of Examples 4-12 were measured and are set forth in Tables 4 and 5. The response of stress-strain characteristics to glycol formulation change can typically be approximated—for a given glycol formulation (e.g., (Example 6/Fiber 1908) vs (Example 9/Fiber 1911)), a decrease in fiber load power (TP2) and unload power (TM2), along with a commensurate increase in elongation (ELO) occurs with increase in glycol molecular weight, owing to the impact of glycol length in structuring the load-bearing hard segments in the polymer matrix. Examples (e.g., (Example 10/Fiber 1912) and (Example 11/Fiber 1914)), which are absent comonomer in the glycol configuration enable a more regular soft segment structure, enabling higher tenacity and % SET due to a greater propensity for association in the soft segment, as % SET is a function of unrecoverable (i.e., plastic) deformation of the fiber under strain. Increasing comonomer concentration which is 2-methyl-1,4-butanediol in the glycol (e.g., trending from (Example 11/Fiber 1914) to (Example 6/Fiber 1908) to (Example 12/Fiber 2011)) induces higher recovery power (TM2) and lower set (SET), through the role of 2-methyl-1,4-butanediol in increasing phase mixing and entropy in the spinning process. This is clearly depicted in the non-blended glycols in Table 4.

Incorporation of 3MCPG, via a blended glycol system in conjunction with the 2MeBDO-comonomer-derived glycol, provides partial functionality of the 3MCPG glycol—notably, 3MCPG glycol enables higher recovery power (TM2) and lower set (SET) in fiber. At a fixed glycol molecular weight, increasing 3MCPG blend ratio (e.g., (Example 9/Fiber 1911) to (Example 8/Fiber 1910) to (Example 7/Fiber 1909) for a 2000 MW), increases the recovery power component of the resultant fiber. This effect occurs similarly for other glycol molecular weights (i.e., 1400 MW). This is clearly depicted in the blended glycols in Tables 4 and 5.

Logically, the benefits observed for poly(urethane urea) elastomeric fibers could also be translated to other poly(urethane urea) architectures and more broadly, the category of polyurethanes of all forms and shapes, e.g. for cast polyurethanes, thermoplastic polyurethanes, adhesives, coating, sealants, foams etc., as well as the broader category of co-polycarbonate glycols, and other species.

TABLE 1
DSC crystallization temperature (Tc) and melting temperatures
(Tm) of the polyester glycols

| Sample ID | Tc (° C.) | Tm1 (° C.) | Tm2 (° C.) |
|---|---|---|---|
| Example 1 | 16.0 | 35.4 | 40.5 |
| Example 2 | 18.6 | 38.7 | 45.5 |
| Example 3 | 10.1 | 30.8 | 38.3 |
| Comparative Example 1 | 27.2 | 41.3 | 47.4 |
| Comparative Example 2 | 28.7 | 45.3 | 50.7 |

TABLE 2
Exemplary formulations
comprising (co) polybutylene polyester glycols

| | | | Glycol | Pre- | Extender |
|---|---|---|---|---|---|
| | | | nominal | polymer | EDA/ |
| | Glycol | Glycol | MW | NCO | DYTEK ®A |
| Part | name | monomers | (g/mole) | (%) | (ratio) |
| 1908 | co- | (10 mole % | 1400 | 2.80 | 90/10 |
| | polybutylene | 2-methyl- | | | |
| | polyester | 1,4-butanediol/ | | | |
| | glycol | 90 mole % | | | |
| | | 1,4-butanediol) | | | |
| | | and adipic acid | | | |
| 1911 | co- | (10 mole % | 2000 | 2.20 | 90/10 |
| | polybutylene | 2-methyl-1,4- | | | |
| | polyester | butanediol/ | | | |
| | glycol | 90 mole % | | | |
| | | 1,4-butanediol) | | | |
| | | and adipic acid | | | |
| 1912 | Polybutylene | 1,4-butanediol | 2000 | 2.20 | 90/10 |
| | adipate | and adipic | | | |
| | polyester | acid | | | |
| 1914 | Polybutylene | 1,4-butanediol | 1400 | 2.80 | 90/10 |
| | adipate | and adipic | | | |
| | polyester | acid | | | |
| 2011 | co- | (20 mole % | 1450 | 2.80 | 90/10 |
| | polybutylene | 2-methyl- | | | |
| | polyester | 1,4-butanediol/ | | | |
| | glycol | 80 mole % | | | |
| | | 1,4-butanediol) | | | |
| | | and adipic acid | | | |

TABLE 3
Exemplary formulations comprising polybutylene adipate
co-polyester glycols in a blended glycol system.

| | | Glycol | Pre- | Extender |
|---|---|---|---|---|
| | | nominal | polymer | EDA/ |
| | Blended Glycol components | MW | NCO | DYTEK ®A |
| Part | ratio and monomer structures | (g/mole) | (%) | (ratio) |
| 1906 | 1—25 wt % co-polybutylene | 1400 | 2.80 | 90/10 |
| | polyester glycol with 10 | | | |
| | mole % 2-methyl- | | | |
| | 1,4-butanediol | | | |
| | 2—75 wt % 3MCPG T-1410 | | | |
| 1907 | 1—50 wt % co-polybutylene | 1400 | 2.80 | 90/10 |
| | polyester glycol with | | | |
| | 10 mole % 2-methyl-1,4 | | | |
| | butanediol | | | |
| | 2—50 wt % 3MCPG T-1410 | | | |
| 1909 | 1—25 wt % co-polybutylene | 2000 | 2.20 | 90/10 |
| | polyester glycol with 10 | | | |
| | mole % 2-methyl- | | | |
| | 1,4-butanediol | | | |
| | 2—75 wt % 3MCPG T-1410 | | | |
| 1910 | 1—50 wt % co-polybutylene | 2000 | 2.20 | 90/10 |
| | polyester glycol with | | | |
| | 10 mole % 2-methyl- | | | |
| | 1,4 butanediol | | | |
| | 2—50 wt % 3MCPG T-1410 | | | |

TABLE 4
As-spun yarn properties of 44 decitex fibers for polymers
comprised of polybutylene adipate copolyester glycols.

| | TP2 | TM2 | SET | ELO | TEN |
|---|---|---|---|---|---|
| Part | (CN) | (CN) | (%) | (%) | (CN) |
| Comparative | 6.94 | 1.18 | 20.9 | 462 | 47.8 |
| Example 3 | | | | | |
| (Fiber T162C) | | | | | |
| Example 6 | 9.64 | 0.89 | 26.4 | 387 | 38.2 |
| (Fiber 1908) | | | | | |
| Example 9 | 7.23 | 0.59 | 25.6 | 468 | 36.8 |
| (Fiber 1911) | | | | | |
| Example 10 | 6.52 | 0.66 | 35.7 | 442 | 45.2 |
| (Fiber 1912) | | | | | |
| Example 11 | 8.62 | 0.75 | 29.4 | 408 | 41.3 |
| Fiber 1914) | | | | | |
| Example 12 | 8.58 | 0.94 | 22.8 | 400 | 56.1 |
| (Fiber 2011) | | | | | |

TABLE 5
As-spun yarn properties of 44 decitex fibers for polymers
comprised of a blended glycol system.

| | TP2 | TM2 | SET | ELO | TEN |
|---|---|---|---|---|---|
| Part | (CN) | (cN) | (%) | (%) | (CN) |
| Comparative | 6.94 | 1.18 | 20.9 | 462 | 47.8 |
| Example 3 | | | | | |
| (Fiber T162C) | | | | | |
| Example 4 | 5.20 | 1.31 | 27.8 | 425 | 28.0 |
| (Fiber 1906) | | | | | |
| Example 5 | 6.04 | 1.33 | 21.1 | 455 | 40.7 |
| (Fiber 1907) | | | | | |
| Example 7 | 5.02 | 1.35 | 19.7 | 486 | 39.5 |
| (Fiber 1909) | | | | | |
| Example 8 | 4.41 | 1.01 | 20.1 | 484 | 34.6 |
| (Fiber 1910) | | | | | |

TABLE 6
As-spun yarn properties of 44 decitex fibers for
polyurethanes comprised of a blended diol (2-methyl-
1,4-butanediol and 1,4-butanediol) system.

| | TP2 | TM2 | ELO | SET | TEN |
|---|---|---|---|---|---|
| Part | (cN) | (cN) | (%) | (%) | (cN) |
| Comparative | 4.63 | 0.68 | 461 | 27.8 | 41.88 |
| Example 4 | | | | | |
| (Fiber T178C) | | | | | |
| Example 13 | 3.52 | 0.62 | 470 | 31.8 | 40.23 |

What is claimed is:

1. A polyester glycol comprising 2-methyl-1,4-butanediol and dicarboxylic acid or a mixture of dicarboxylic acids.

2. The polyester glycol of claim 1 further comprising 1,4-butanediol.

3. The polyester glycol of claim 1, wherein the dicarboxylic acid is adipic acid.

4. The polyester glycol of claim 2, where the dicarboxylic acid is adipic acid, and the mole ratio of 1,4-butanediol to 2-methyl-14-butanediol from 99:1 to 70:30, and a number-average molecular weight range from 600 to 4,000 g/mol.

5. The polyester glycol of claim 2, where the dicarboxylic acid is adipic acid, and the mole ratio of 1,4-butanediol to 2-methyl-1,4-butanediol from 99:1 to 80:20, and a number-average molecular weight range from 1,000 to 2,400 g/mol.

6. A polyurethane or poly(urethane urea) composition comprising the polyester glycol of claim 1.

7. A fiber comprising the polyester glycol of claim 1.

8. A fiber comprising the polyurethane or poly(urethane urea) composition of claim 6.

9. A method for producing spandex fiber, said method comprising spinning the polyurethane or poly(urethane urea) composition of claim 6 into a fiber.

10. An article of manufacture, at least a portion of which comprises the polyester glycol of claim 1.

11. The article of manufacture of claim 10, wherein said portion comprises a spandex elastomeric fiber incorporated into a fabric knit or woven structure, or non-woven structure.

12. The article of manufacture of claim 10 which is a disposable hygiene product, disposable diaper, training pant or adult incontinence device or product, a catamenial device or garment or product thereof, a bandage, a wound dressing, a surgical drape, a surgical gown, a surgical or other hygienic protective mask, hygienic gloves, a head covering, a head band, an ostomy bag, a bed pad or abed sheet.

13. A polyurethane comprising 2-methyl-1,4-butanediol.

14. An elastomeric fiber comprising the polyurethane of claim 13 formed into fiber through a melt spinning or dry spinning process.

15. An article of manufacture at least a portion of which comprises the polyurethane of claim 13.

16. A method for producing a spandex fiber comprising:
(a) providing a glycol formed from 2-methyl-1,4-butanediol and 1,4-butanediol and adipic acid, optionally blended with a polyether polyol, a polyester polyol, a polycarbonate polyol, and combinations thereof;
(b) contacting the glycol of step (a) with a diisocyanate to form a capped glycol;
(c) contacting the capped glycol of step (b) with a chain extender and a chain terminator composition in a solvent to form a poly(urethane urea) in solution; and
(g) spinning the poly(urethane urea) in solution to form the spandex.

17. An article of manufacture at least a portion of which comprises the fiber of claim 14.
